(19) United States
(12) Patent Application Publication
(10) Pub. No.: US 2010/0284843 A1
(43) Pub. Date: Nov. 11, 2010

(54) Stator for an eccentric screw pump or an eccentric screw motor and method of producing a stator

(76) Inventor: Sebastian Jäger, Hannover (DE)

Correspondence Address: ROBERT W. BECKER & ASSOCIATES, 707 HIGHWAY 333, SUITE B, TIJERAS, NM, 87059-7507, US

(21) Appl. No.: 12/436,011

(22) Filed: May 5, 2009

(51) Int. Cl. F01C 1/10; F01C 5/04; F04C 2/107; B23P 15/00

(52) U.S. Cl. 418/48; 418/153; 418/220; 29/888.023

(57) ABSTRACT

A stator and method of producing a stator for an eccentric screw pump or an eccentric screw motor, including an outer stator tube, at least one stator segment disposed within the outer stator tube, and at least one tube end portion that completes one end of the outer stator tube. A region of the tube end portion that in an axial direction follows the outer stator tube has a thickness that is greater than the thickness of the outer stator tube. The outer stator tube is radially deformed to produce a connection between the at least one stator segment and outer stator tube.

The present invention relates to a stator for an eccentric screw pump or an eccentric screw motor, and a method of producing a stator.

Eccentric screw pumps or eccentric screw motors that operate pursuant to the Moineau principle are fundamentally known. Such pumps and motors generally include a stator and a rotor disposed in the interior of the stator. The stator includes a stator tube made of a relatively hard material, and an elastomeric lining connected with the inner surface of the stator tube. In this connection, the lining is formed in the manner of a multiple, helical coarse thread and forms a hollow space in which is accommodated the rigid rotor, which is also formed in the manner of a helical coarse thread, whereby the rotor generally has one fewer thread than does the stator.

A stator for an eccentric screw pump or an eccentric screw motor that operates according to the Moineau principle is disclosed in U.S. Pat. No. 7,396,220 B2. The stator includes a plurality of stator segments arranged axially one after the other. Each stator segment has a helical inner segment surface. In the joined together or combined state the individual segment surfaces complement one another to form a helical inner stator surface. The stator additionally includes an elastomeric lining that covers the inner stator surface comprised of the individual helical inner segment surfaces with a uniform layer thickness. For the fixation of the individual stator segments in their position, the stator includes an outer stator tube. The stator segments are disposed within the outer stator tube, whereby an elastomer is sprayed between the outer surface of the stator segments and the inner surface of the outer stator tube to establish a material connection between outer stator tube and the stator segments. The orientation of the stator segments relative to one another is ensured by pins that for the prevention of a rotation or twisting of adjacent stator segments respectively positively engage in two adjacent stator segments. An alternative for the fixation of the stator segments is the provision, in an outer tube that surrounds the stator segments, of one or more grooves that extend in the axial direction and into which projections of the stator segments engage in a positive manner. In order to be able to introduce the stator segments into the stator tube as an assembly, the stator segments can be stacked onto a helical spindle.

The object of the present invention is to provide a stator that ensures a reliable fixation of at least one stator segment within an outer stator tube, and that can be produced in an economical manner. A further object is to provide a method for the production of a stator.

These objects are realized by a stator and a method of producing a stator pursuant to the independent claims.

Advantageous further developments are the subject of the dependent claims.

The inventive stator for an eccentric screw pump or an eccentric screw motor includes an outer stator tube, at least one stator segment, and at least one tube end portion, whereby the at least one stator segment is disposed within the outer stator tube, and the at least one tube end portion completes the outer stator tube at one end thereof, whereby the thickness of the tube end portion in a region that in the axial direction follows the outer stator tube is greater than the thickness of the outer stator tube, and whereby the outer stator tube (2) is radially deformed to produce a connection between the at least one stator segment (3a, 3b, 3c) and the outer stator tube (2).

The connection between the at least one stator segment and the outer stator tube, which is effected by the radial deformation of the outer stator tube, enables a fixation of the at least one segment not only in the axial direction, but also against a rotation about its axis. In this connection the connection can be embodied as a frictional connection and/or as a material connection by using an adhesive. In principle, no additional measures are required for the fixation of the segment. The greater thickness of the tube end portion relative to the outer stator tube additionally enables an outer abutment for the at least one segment, thus achieving an improvement of the fixation of the at least one segment in the axial direction. Furthermore, the greater thickness of the tube end portion enables the formation of a thread, by means of which for example a tool, or a conduit or wire system, can be connected with the stator.

The invention will be explained in greater detail subsequently with the aid of exemplary embodiments that are illustrated in a number of figures, in which:

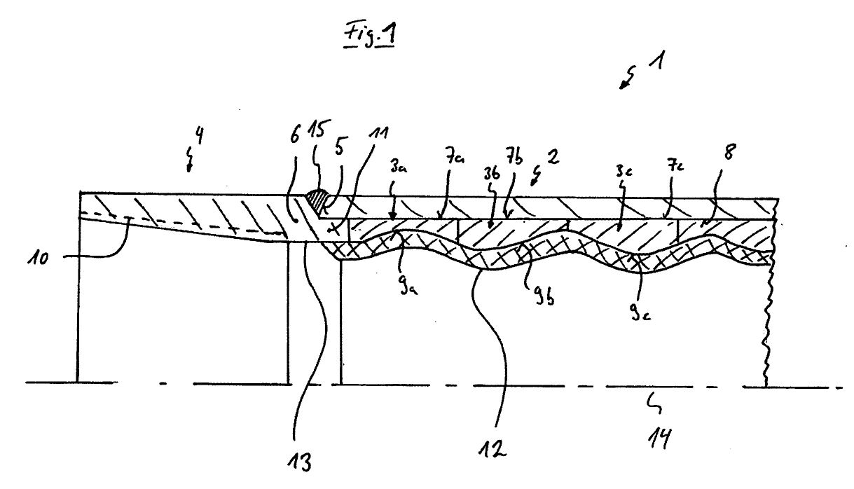

FIG. 1: shows a longitudinal section through a portion of a first exemplary embodiment of an inventive stator, whereby to facilitate illustration the lower half of the stator is not shown,

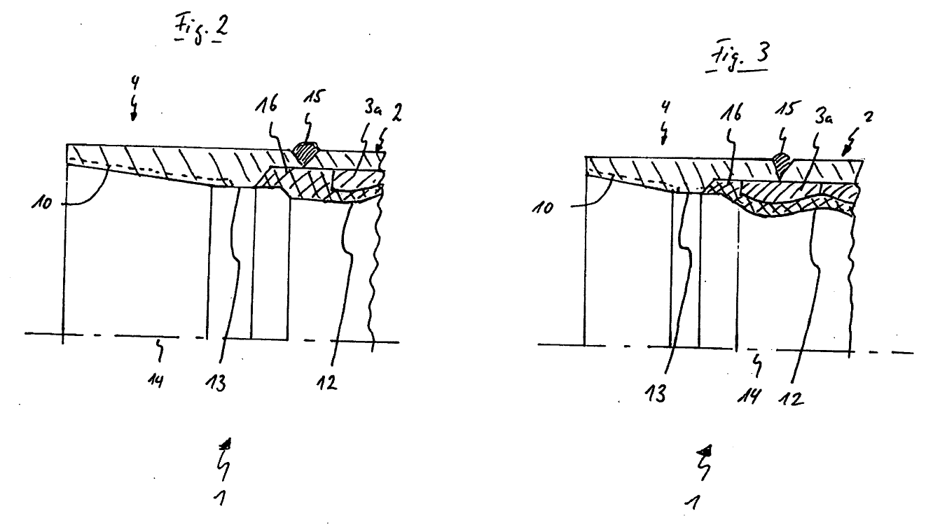

FIG. 2: is a longitudinal section through a portion of a second exemplary embodiment of an inventive stator,

FIG. 3: is a longitudinal section through a portion of a third exemplary embodiment of an inventive stator,

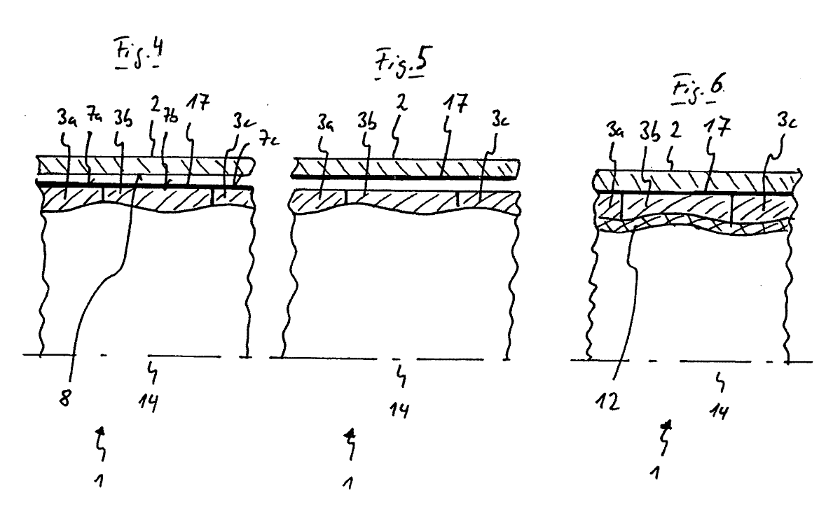

FIG. 4: is a longitudinal section through a portion of a fourth exemplary embodiment of an inventive stator in an intermediate state of an inventive manufacturing method,

FIG. 5: is a longitudinal section through a portion of the fourth exemplary embodiment of an inventive stator in an intermediate state of an alternative inventive manufacturing method,

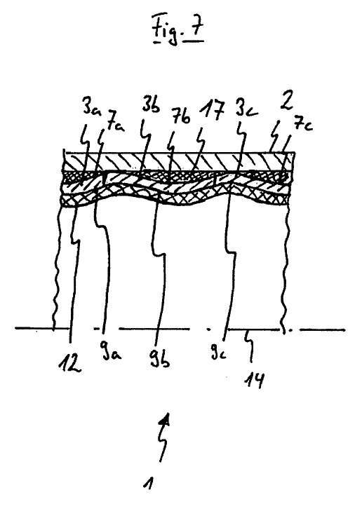

FIG. 6: is a longitudinal section through a portion of the fourth embodiment of an inventive stator in an end state, and

FIG. 7: is a longitudinal section through a portion of a fifth exemplary embodiment of an inventive stator.

The same elements, or elements that correspond to one another, have the same reference numerals in the figures.

The illustrated stator 1 is a stator 1 for an eccentric screw pump or an eccentric screw motor that operates pursuant to the Moineau principle. The stator 1 includes an outer stator tube 2, a plurality of stator segments, of which three are designated by way of example with 3a, 3b, 3c, two tube end portions 4, and a lining 12. Since only a portion of the stator is illustrated, only a portion of the outer stator tube 2, the stator segments and the lining 12, as well as only one of the tube end portions 4, are visible in the figure. The stator segments 3a, 3b, 3c are disposed within the outer stator tube 2. A respective tube end portion 4 completes or concludes the outer stator tube at an end 5 of the outer stator tube 2. In this connection, a respective tube end portion 4 abuts directly against the outer stator tube 2 and one stator segment.

The outer stator tube 2 is embodied as a tube having a cylindrical outer surface. The tube end portion 4 also has a cylindrical outer surface. The outer surfaces of the tube end portion 4 and of the outer stator tube 2 essentially have the same outer diameter. Proceeding from that end of the tube end portion 4 that faces away from the outer stator tube 2, the end portion inner surface 13 of the tube end portion 4 initially tapers conically. Provided in this conical region is a conical or tapered thread 10 for the securement of, for example, a tool. Alternatively, a linear thread can also be provided. Subsequently adjoining the conical region is an intermediate region 6 in which the inner surface 13 of the tube end portion has a constant inner diameter. In the intermediate region 6 the inner diameter of the tube end portion 4 is less than the inner diameter of the outer stator tube 2. The tube end portion 4 thus has a thickness in the intermediate region 6 that is greater than the thickness of the outer stator tube 2. The thickness of the tube end portion 4 in the intermediate region 6 is preferably about at least 20 percent greater than the thickness of the outer stator tube 2. The outer diameter of the tube end portion 4 is subsequently reduced in the manner of a step. The tube end portion 4 ends in an annular engagement portion 11 that engages or extends into the outer stator tube 2, with the outer tube inner surface 8 at one end of the outer stator tube 2 resting upon the engagement portion.

Each of the stator segments 3a, 3b, 3c is disk shaped, with a cylindrical outer segment surface 7a, 7b, 7c, two bases that extend in a planar manner and parallel to one another, and an inner segment surface 9a, 9b, 9c that has a helical shape or approximates a helical shape. The stator segments are disposed axially one after another along the central axis 14 that is prescribed by the outer stator tube 2, so that the bases of adjacent stator segments are respectively disposed across from one another. The outwardly disposed stator segment, as viewed in the axial direction, namely the stator segment 3a in FIG. 1, butts directly against the portion 11 of a tube end portion 4, which in this manner forms an abutment for this stator segment. In this manner, the stator segments 3a, 3b, 3c are disposed in a positively engaging manner in the axial direction between the engagement portions 11 of the tube end portions 4. The outer diameter of a stator segment 3a, 3b, 3c essentially corresponds to the outer diameter of the tubular engagement portion 11.

The stator segments 3a, 3b, 3c rest directly against the inner surface 8 of the outer stator tube 2. The outer stator tube 2 is radially compressed or deformed, so that the outer stator tube 2 is positively or frictionally connected with the individual stator segments 3a, 3b, 3c via the inner surface 8 of the outer stator tube and the respective outer segment surfaces 7a, 7b, 7c. By means of the frictional connection the stator segments 3a, 3b, 3c are fixed in their positions, in particular against a movement in the axial direction and against a rotational movement.

The tube end portion 4 disposed at the respective end of the outer stator tube 2 is fixedly connected with the outer stator tube 2 via a welding 15. In addition, or alternatively, the tube end portion 4 can be positively or frictionally connected with the outer stator tube 2 by means of a radial compression or deformation of the outer stator tube 2 in the region of the engagement portion 11 of a tube end portion 4.

The inner surface 13 of a tube end portion 4 is flush with the inner segment surface 9a of the respectively abutting stator segment 3a. The individual inner segment surfaces 9a, 9b, 9c complement one another to form an overall surface that is helical or approximates a helical form. The overall inner surface, which is comprised of the individual inner segment surfaces 9a, 9b, 9c, including a region of the inner surface 13 of the respective tube end portion 4, are covered with the lining 12. The lining 12 is an elastomer, for example a rubber. The lining 12 is fixedly connected with the inner segment surfaces 9a, 9b, 9c and the overlapping region of the inner surface 13 of the tube end portion 4, for example by means of a vulcanization process. The lining 12 has an essentially uniform thickness.

For the production of such a stator 1, first the individual stator segments 3a, 3b, 3c are produced. The production of the stator segments 3a, 3b, 3c with an inner segment surface 9a, 9b, 9c that is helical or approximates a helical shape can be effected, for example, by casting, by milling, by stamping or by beam or jet cutting. The stator segments 3a, 3b, 3c are subsequently disposed within the outer stator tube 2. To facilitate the arrangement of the stator segments 3a, 3b, 3c within the outer stator tube 2, the stator segments 3a, 3b, 3c can be stacked on a spindle having a preferably helical surface. The outer stator tube 2, which has not yet been radially deformed, has an inner surface 8 having an inner diameter that is greater than the outer diameter of the outer segment surfaces 7a, 7b, 7c of the stator segments 3a, 3b, 3c. After arranging the stator segments 3a, 3b, 3c within the outer stator tube 2, the outer stator tube 2 is radially deformed, so that a positive or frictional connection is achieved between outer stator tube 2 and the stator segments 3a, 3b, 3c. If a spindle is used, the spindle ensures the desired arrangement of the individual stator segments 3a, 3b, 3c even during the deformation.

The tube end portions 4 for the ends are subsequently secured to the outer stator tube 2. The production of the lining 12 is effected thereafter, for example by means of a molding process.

It is furthermore possible to connect the stator segments 3a, 3b, 3c by means of an interlocking connection. The interlocking is preferably formed between adjacent stator segments 3a, 3b, 3c. Such an interlocking connection can, for example, be formed by teeth or tongue and groove connections of the stator segments 3a, 3b, 3c and/or by the additional use of pins (not illustrated). Such an interlocking connection can also be formed between a tube end portion 4 and the adjacent stator segment 3a.

In the illustrated embodiment, the stator segments 3a, 3b, 3c are made of metal, here aluminum. Alternatively, a possible material would also be ceramic or a cross-linked or thermoplastic polymer. The outer stator tube and the tube end portions 4 are also made of metal, here, a steel.

FIGS. 2 and 3 show a second and a third embodiment respectively of an inventive stator 1.

The stator 1 pursuant to the second and the third embodiment is a variant of the stator 1 of the first embodiment shown in FIG. 1. In a departure from the first embodiment, the tube end portion 4 does not abut directly against the axially outward stator segment 3a, so that a gap 16 is present between the tube end portion 4 and the outwardly disposed stator segment 3a. The gap 16 is filled by the lining 12. The lining 12 is flush with the region of the tube end portion 4 having the minimum inner diameter.

Pursuant to the second embodiment, see FIG. 2, the minimum inner radius of the tube end portion 4 corresponds to the maximum inner radius of the outwardly disposed stator segment 3a; pursuant to the third embodiment, see FIG. 3, the minimum inner radius of the tube end portion 4 corresponds to the minimum inner radius of the outwardly disposed stator segment 3a.

FIGS. 4 and 5 show intermediate states of two alternative methods for the production of a stator 1 pursuant to a fourth embodiment. FIG. 6 shows the produced stator 1 pursuant to the fourth embodiment.

As a further development of the above-described method, it is additionally possible to provide an adhesive 17 between the outer segment surfaces 7a, 7b, 7c and the inner surface 8 of the outer stator tube in order in addition to or in place of a frictional connection to achieve a positive material connection between the individual stator segments 3a, 3b, 3c and the outer stator tube 2. The fixation of the stator segments 3a, 3b, 3c in the outer stator tube 2 can be improved in this manner.

The adhesive 17, preferably prior to arranging the stator segments 3a, 3b, 3c within the outer stator tube 2, is applied to the inner surface 8 of the outer stator tube 2 (see FIG. 4), or alternatively to the outer segment surfaces 7a, 7b, 7c of the stator segments 3a, 3b, 3c (see FIG. 5). Similarly, it is also possible to apply the adhesive 17 not only to the outer segment surfaces 7a, 7b, 7c but also to the inner surface 8 of the outer stator tube (not illustrated). Furthermore, it is also possible to apply the adhesive 17 after disposing the stator segments 3a, 3b, 3c within the outer stator tube 2 and prior to the deformation of the outer stator tube 2.

Subsequently, the radial deformation of the outer stator tube 2 is effected. The deformation of the outer stator tube 2 after the application of the adhesive 17 is advantageous, since by providing a sufficiently large gap between the non-deformed outer stator tube 2 and stator segments 3a, 3b, 3c, the arrangement of the stator segments 3a, 3b, 3c within the outer stator tube 2 is not obstructed by adhesive 17 that has been applied. By providing such a sufficiently large gap, it is also possible with stator segments 3a, 3b, 3c disposed within the outer stator tube 2 to subsequently introduce an adhesive 17, for example by molding or pouring, into the intermediate space between outer stator tube 2 and stator segments 3a, 3b, 3c whereby in particular even great lengths of the stator 1 are not problematic. By means of the radial deformation, the gap between outer stator tube 2 and the stator segments 3a, 3b, 3c is reduced until the material connection between outer stator tube 2 and the stator segments 3a, 3b, 3c is established and/or the gap between outer stator tube 2 and the stator segments 3a, 3b, 3c has the final, provided size. A radial deformation of the outer stator tube 2 from the interior toward the outside or from one end to the other end of the outer stator tube 2 is advantageous in order to displace excessive adhesive 17 and/or to achieve the formation of a uniformly thick layer of adhesive 17.

Suitable adhesives are, for example, thermosetting plastics, anaerobically hardening adhesive, or dual-component adhesives.

If only a portion of the outer segment surface 7a, 7b, 7c and the inner surface 8 of the outer stator 2 are coated with adhesive 17, then in addition to the material connection effected by the adhesive 17, by means of a radial deformation of the outer stator tube 2 a frictional or positive connection can be established between the regions of the outer segment surfaces 7a, 7b, 7c not covered with adhesive 17 and the inner surface 8 of the outer stator tube 2. In this case, not only is a frictional connection provided but also a material connection.

FIG. 7 shows a portion of a fifth embodiment of an inventive stator 1. The stator 1 pursuant to the fifth embodiment is a variant of the stator illustrated in FIG. 6. Instead of a cylindrical outer segment surface, the stator segments 3a, 3b, 3c have a helical outer segment surface 7a, 7b, 7c, the path of which corresponds to the path of the respective inner segment surface 9a, 9b, 9c. The gap between outer stator tube 2 and the segments 3a, 3b, 3c is filled with adhesive 17. The above-described methods can be utilized for producing such a stator 1.

1-21. (canceled)

22. A stator for an eccentric screw pump or an eccentric screw motor comprising;
an outer stator tube,
at least one stator segment disposed within said outer stator tube, and
at least one tube end portion that completes one end of said outer stator tube, wherein a region of said at least one tube end portion that in an axial direction follows said outer stator tube has a thickness that is greater than the thickness of said outer stator tube, and wherein said outer stator tube is adapted to be radially deformed to produce a connection between said at least one stator segment and said outer stator tube.

23. A stator according to claim 22, wherein said at least one stator segment 3b, is connected in a frictional or positive manner, or in a material manner, with the radially deformed outer stator tube.

24. A stator according to claim 22, wherein a minimum inner diameter of said at least one tube end portion is less than a minimum inner diameter of said outer stator tube.

25. A stator according to claim 22, wherein said at least one tube end portion butts directly against at least one of said outer stator tube and one of said stator segments.

26. A stator according to claim 22, which includes a first tube end portion and a second tube end portion, wherein in an axial direction said at least one stator segment is positively disposed between said first tube end portion and said second tube end portion.

27. A stator according to claim 22, which includes a plurality of stator segments that are disposed axially one after another within said outer stator tube.

28. A stator according to claim 22, wherein at least a portion of an outer segment surface of said at least one stator segment rests directly against an inner surface of said outer stator tube.

29. A stator according to claim 22, wherein said at least one stator segment has a helical inner segment surface or an inner segment surface that approximates a helix form.

30. A stator according to claim 22, wherein said at least one stator segment has an outer segment surface that has a cylindrical or helical configuration.

31. A stator according to claim 22, wherein said at least one stator segment is made of a metal, a ceramic, or a cross-linked or thermoplastic polymer.

32. A stator according to claim 22, where said at least one tube end portion (4) is provided with a securement means.

33. A stator according to claim 22, wherein said at least one tube end portion is provided with a tubular engagement portion that engages into said outer stator tube.

34. A stator according to claim 22, which includes an elastomeric lining , wherein said lining is disposed on an inner segment surface of said at least one stator segment, and preferably on an inner surface of said at least one tube end portion.

35. A stator according to claim 22, which includes an adhesive that, to establish a material-type connection between said outer stator tube and said at least one stator segment, is disposed between at least a portion of an inner surface of said outer stator tube and an outer segment surface of said at least one stator segment.

36. A stator according to claim 22, wherein said at least one stator segment is positively connected with a further stator segment or with said at least one tube end portion.

37. A method of producing a stator for an eccentric screw pump or an eccentric screw motor, including the steps of:
providing an outer stator tube,
arranging at least one stator segment within said outer stator tube, and
radially deforming said outer stator tube to produce a connection between said outer stator tube and said at least one stator segment.

38. A method according to claim 37, wherein a frictional or positive connection is established between said outer stator tube and said at least one stator segment by means of said step of radially deforming said outer stator tube.

39. A method according to claim 37 which includes the additional step of providing a material connection between said outer stator tube and said at least one stator segment by means of an adhesive.

40. A method according to claim 39, which includes the further step of applying the adhesive, prior to said step of radially deforming said outer stator tube, onto at least one of an outer segment surface of said at least one stator segment and an inner surface of said outer stator tube.

41. A method according to claim 37, wherein said step of radially deforming said outer stator tube is effected from the interior toward the outside or from one end to another end of said outer stator tube.
